(19) United States
(12) Patent Application Publication
(10) Pub. No.: US 2005/0087352 A1
(43) Pub. Date: Apr. 28, 2005

(54) Portable Tool

(75) Inventor: Diethard Fohr, Winnenden (DE)

Correspondence Address: GUDRUN E. HUCKETT DRAUDT, LONSSTR. 53, WUPPERTAL, 42289, DE

(73) Assignee: ATLAS COPCO ELECTRIC TOOLS GMBH, Winnenden (DE)

(21) Appl. No.: 10/905,405

(22) Filed: Jan. 3, 2005

Related U.S. Application Data
(63) Continuation of application No. PCT/EP02/07396, filed on Jul. 4, 2002.

(51) Int. Cl. B25D 9/00

(52) U.S. Cl. 173/114; 173/131

(57) ABSTRACT

A portable tool such as a chisel hammer or drill hammer has a receptacle for receiving a tool insert. A hammer member drives percussively the tool insert received in the receptacle. The hammer member is movable in the direction of the longitudinal axis of the tool insert. The hammer member has a greater mass than a same-size reference hammer member of steel. The mass of the hammer member is at least 140 percent greater than that of the reference hammer member.

This application is a continuation of international application Ser. No. PCT/EP2002/007396 having an international filing date of Jul. 4, 2002, not published in English under PCT Article 21(2), and now abandoned.

### BACKGROUND OF THE INVENTION

The invention relates to a portable tool, in particular, a chisel hammer or a drill hammer, comprising a receptacle for a tool insert and comprising a hammer member for operating the tool insert in hammer operation. The hammer member is movable in the direction of the longitudinal axis of the tool insert.

European patent application 1 160 057 A1 discloses a hand-held drill hammer having a hammer device with a hammer piston for driving the tool insert in hammer operation (percussive operation).

### SUMMARY OF THE INVENTION

It is an object of the present invention to improve the portable tool of the aforementioned kind such that a high hammering or drilling efficiency can be obtained.

In accordance with the present invention, this is achieved in that the hammer member has a greater mass than a same-size reference hammer member made of steel.

The increased mass of the hammer member increases the hammer energy (percussion energy) and thus leads to an increase of the hammer efficiency or, for simultaneous rotary and hammer operation, to an increase of the drilling efficiency. Surprisingly, it was found that the efficiency increases more than proportionally relative to the motor output. Experiments have shown that, when increasing the weight of the hammer member by approximately 90 percent, an increase of the drilling efficiency by 30 percent is achieved while the motor output is increased only by 10 percent. For identical size of the tool, in particular, a drill hammer, it is thus possible to achieve an efficiency increase. The weight increase is relatively small compared to the total weight of the drill hammer. The more than proportional increase of the hammer energy leads to an improved efficiency of the system as a whole.

Advantageously, the mass of the hammer member is at least 140 percent, in particular, more than 160 percent that of a same-size reference hammer member made of steel. Advantageously, the hammer member is made of hard metal, wherein the hammer member has a density of 12.0 kg/dm³ to 13.0 kg/dm³, in particular, approximately 12.85 kg/dm³. However, it can also be advantageous to fill the hammer member with a material of high density, in particular, lead. Filling the hammer member with other materials can also be advantageous.

Advantageously, the hammer member is a hammer piston that is axially movable in a hammer cylinder and is moved, in particular, hydraulically within the hammer cylinder. In such a hammer system, a doubling of the hammer efficiency relative to a hammer piston made of steel is achieved. For a hydraulically driven hammer piston it is provided that the first pressure surface of the hammer piston for moving the hammer piston in the direction toward the tool insert is greater than the second pressure surface for moving the hammer piston in the opposite direction; in particular, the first pressure surface is multiple times greater than the second pressure surface.

### BRIEF DESCRIPTION OF THE DRAWING

FIG. 1 is a side view of a portable drill hammer, partially in section.

FIG. 2 shows the hammer system comprised of hammer cylinder and hammer piston, partially in section.

FIG. 3 is a perspective view of the hammer system of FIG. 2.

FIG. 4 is a side view of a hammer piston.

FIG. 5 is an end view of the hammer piston in the direction of arrow V of FIG. 4.

FIG. 6 is a perspective view of the hammer piston of FIG. 5.

### DESCRIPTION OF THE PREFERRED EMBODIMENTS

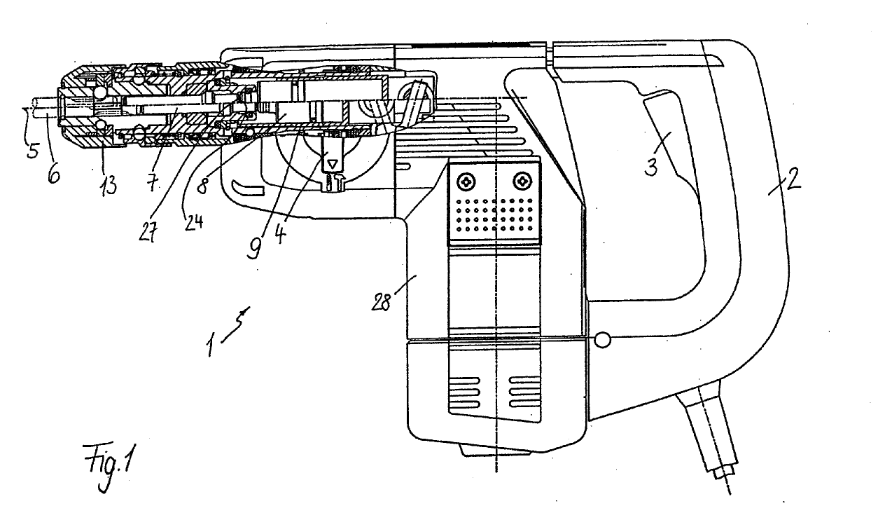

The portable drill hammer illustrated in FIG. 1 has a tool insert 6 that is driven in rotation about longitudinal axis 5 and can be reciprocated in an oscillating fashion for hammer operation in the direction of the longitudinal axis 5. The drill hammer 1 has a handle 2 and an operating lever 3 arranged on the handle 2. The selector lever 4 allows selection of the operating modes, i.e., rotary or hammer operation or combined rotary/hammer operation (position of the selector lever 4 illustrated in FIG. 1). The tool insert 6 is secured in a chuck 13. As a hammer element a hammer piston 8 is provided that is arranged in a hammer cylinder 9 so as to be moveable in the direction of the longitudinal axis 5. With the hammer surface 24, the hammer piston 8 hits the striker 7 that, in turn, hits the tool insert 6. Above and below the longitudinal axis 5 of the tool insert 6 different positions of the striker 7, the hammer piston 8, and the hammer cylinder 9 are illustrated in FIG. 1. For increasing the impact energy (hammer energy), the hammer piston 8 that represents the hammer member is made of hard metal having a density of approximately 12.85 kg/dm³. Expediently, the mass of the hammer piston relative to a reference hammer piston made of steel is increased by at least 40 percent, in particular by more than 60 percent.

In FIG. 2, one embodiment of a hammer system 14 is illustrated that comprises a hammer cylinder 9 and a hammer piston 8. The hammer piston 8 is guided in the hammer cylinder 9 so as to be moveable longitudinally along the axis 27 of the hammer system 14. The axis 27 of the hammer system 14 extends for a hammer system 14 arranged in a drill hammer 1 along the longitudinal axis 5 of the tool insert 6 mounted in the drill hammer 1. The hammer cylinder 9 has screws 22 for fixation of the hammer cylinder 9 in a housing 28 of the drill hammer 1 illustrated in FIG. 1. However, it can also be expedient to secure the hammer cylinder by means of a clamping sleeve and to provide a hexagon 29 on the side of the hammer cylinder 9 facing the striker 7 as a securing means against rotation. It is also possible to provide a different flange connection.

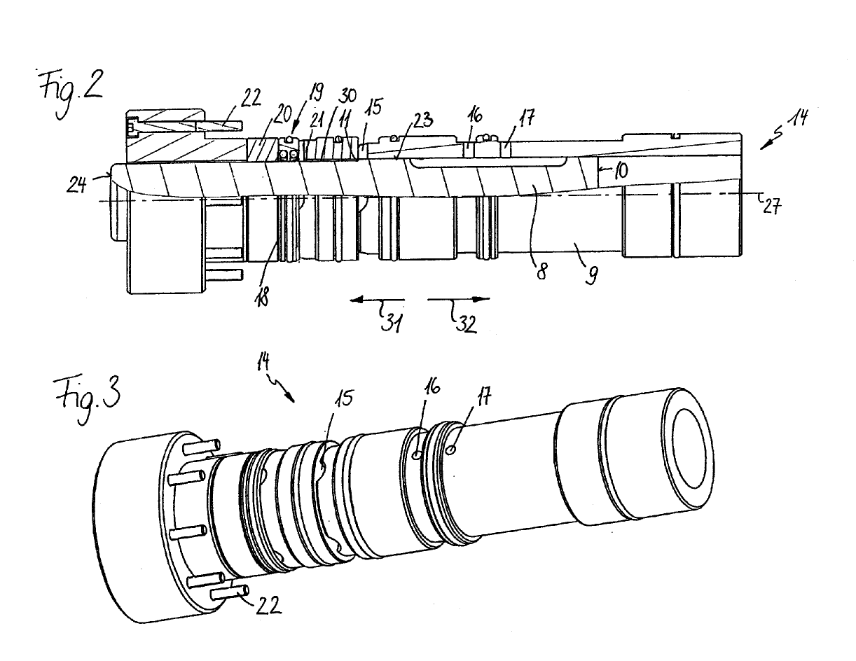

For moving the hammer piston 8 in the hammer cylinder 9 along the axis 27, the oil inlet 15 and the oil outlet 17, illustrated in a perspective view in FIG. 3, are provided. In the axial direction between oil inlet 15 and oil outlet 17 at least one control bore 16 is arranged. Pressurized oil that flows through the oil inlet 15 into the annular gap 30 formed between the hammer piston 8 and the hammer cylinder 9 acts on the pressure surface 11 on the hammer piston 8 and effects thus a movement of the hammer piston in the movement direction 32 that is opposite to the movement direction 31 in the direction toward the tool insert 6. In this connection, it is required that the oil inlet 15 is not completely closed relative to the annular gap 30. The control bore 16 is opened or closed by the control surface 23 on the hammer piston 8 as a function of the position of the impact piston 8. For moving the hammer piston 8 in the movement direction 31 in the direction toward the tool insert 6, the pressure surface 10 is loaded with pressure. The pressure surface 10 has a size (surface area) that is a multiple of the size of the pressure surface 11; it extends, in particular, across the entire cross-sectional surface of the hammer piston 8.

When moving the hammer piston 8 in the movement direction 31, the hammer surface 24 impacts on the striker 7 illustrated in FIG. 1. The latter actuates the tool insert 6. The hammer piston 8 can be guided with its end facing the striker 7 on the guide 21 in the hammer cylinder 9. For sealing in the direction toward the striker 7, a seal receptacle 18 is provided on the hammer cylinder 9; the seal 19 is arranged therein. The seal 19 is comprised expediently of several seal elements. The seal 19 rests against a spacer 20.

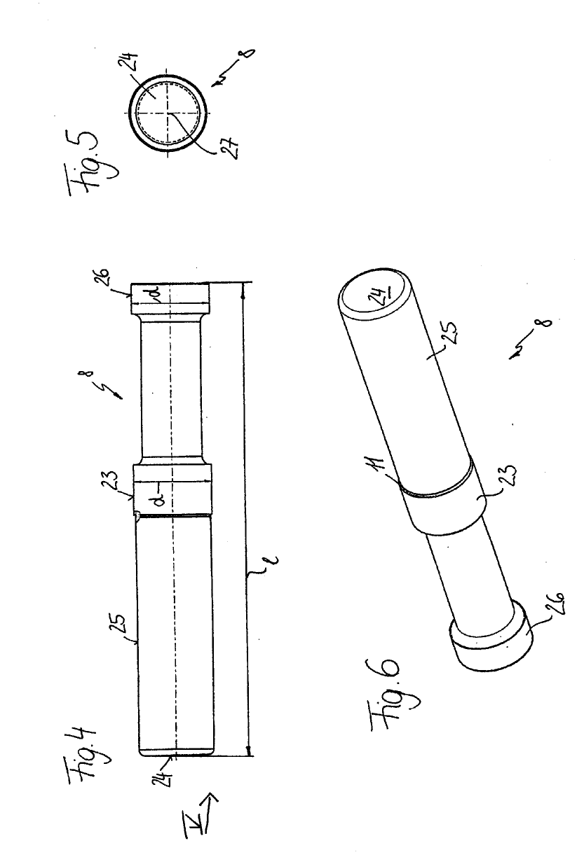

The hammer piston 8 is illustrated separately in FIGS. 4 through 6. The hammer piston 8 is guided by means of the forward guide surface 25, the control surface 23, and the rear guide surface 26 in the hammer cylinder 9. In the area of the rear guide surface 26 and the control surface 23, the hammer piston 8 has a diameter d of approximately 39 mm. The length l of the hammer piston 8, i.e., the extension of the hammer piston 8 in the direction of the axis 27, is approximately 235 mm. On the forward guide surface 25, a bezel that passes into the impact surface 24 can be provided. The impact surface 24 is spherical or rounded.

The hammer piston 8 has relative to a reference hammer piston made of steel and having the same size an increased mass. The mass of the hammer piston 8 that represents the hammer member is 140 percent, in particular, more than 160 percent, of the mass of a same-size reference hammer member made of steel. Advantageously, the hammer member is made of hard metal, in particular, a hard metal having a density of approximately 12.85 kg/dm³. Advantageously, densities of 12.0 kg/dm³ to 13.0 kg/dm³ can be used. It can also be advantageous to fill the hammer member with a high-density material, for example, with lead or with other materials having a high density. Advantageously, the jacket of the hammer member is made of steel in this case. The hammer member can be used in mechanical hammer systems as well as pneumatic or hydraulic hammer systems. Expediently, the hammer member is used in chisel hammers or drill hammers. The term chisel hammer refers, in particular, to tools that have no rotary drive for the tool insert.

While specific embodiments of the invention have been shown and described in detail to illustrate the inventive principles, it will be understood that the invention may be embodied otherwise without departing from such principles.

1. A portable tool comprising:
a receptacle adapted to receive a tool insert;
a hammer member adapted to percussively drive a tool insert received in the receptacle, wherein the hammer member is movable in a direction of a longitudinal axis of the tool insert;
wherein the hammer member has a greater mass than a same-size reference hammer member of steel.

2. The portable tool according to claim 1, wherein the mass of the hammer member is at least 140 percent greater than that of the reference hammer member.

3. The portable tool according to claim 2, wherein the mass of the hammer member is more than 160 percent greater than that of the reference hammer member.

4. The portable tool according to claim 1, wherein the hammer member is a hard metal body.

5. The portable tool according to claim 1, wherein the hammer member has a density of 12.0 kg/dm³ to 13.0 kg/dm³.

6. The portable tool according to claim 5, wherein the hammer member has a density of approximately 12.85 kg/dm³.

7. The portable tool according to claim 1, wherein the hammer member is filled with a high-density material.

8. The portable tool according to claim 7, wherein the high-density material is lead.

9. The portable tool according to claim 1, further comprising a hammer cylinder, wherein the hammer member is a hammer piston arranged in the hammer cylinder so as to be moveable in an axial direction of the hammer cylinder.

10. The portable tool according to claim 9, wherein the hammer piston is adapted to be hydraulically moved in the hammer cylinder.

11. The portable tool according to claim 10, wherein the hammer piston has a first pressure surface for moving the hammer piston in a direction toward the tool insert and a second pressure surface for moving the hammer piston in an opposite direction away from the tool insert, wherein the first pressure surface is greater than the second pressure surface.

12. The portable tool according to claim 11, wherein the first pressure surface is multiple times greater than the second pressure surface.

13. The portable tool according to claim 9, wherein the hammer cylinder has at least one control bore.

14. The portable tool according to claim 1, comprising a switchable rotary drive for additionally driving the tool insert in rotation about the longitudinal axis.

15. The portable tool according to claim 1, wherein the tool is a chisel hammer or a drill hammer.
